(19) United States
(12) Patent Application Publication
(10) Pub. No.: US 2007/0165730 A1
(43) Pub. Date: Jul. 19, 2007

(54) TRANSMITTER CELLULAR COMMUNICATION SYSTEM AND METHOD OF TRANSMITTING THEREFOR

(75) Inventors: Nick W. Whinnett, Marlborough (GB); Amitava Ghosh, Buffalo Grove, IL (US); Jun Tan, Lake Zurich, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/539,220

(22) Filed: Oct. 6, 2006

Related U.S. Application Data
(60) Provisional application No. 60/759,683, filed on Jan. 17, 2006.

(51) Int. Cl. H04K 1/10

(52) U.S. Cl. 375/260

(57) ABSTRACT

A transmitter comprises functionality (101, 103) for generating a block of input modulation symbols for example from received data bits. An M-point discrete Fourier transform (105) is applied to the block of input modulation symbols resulting in a frequency domain symbol block. This block is fed to an N-point inverse discrete Fourier transform (105) (N>M) thereby generating a time domain transmit signal. In addition, the transmitter (200) comprises an inter-symbol processor (201) which determines inter-symbol values corresponding to inter-symbol times of the time domain transmit signal and an attenuation processor (203) which attenuates at least one of the input modulation symbols in response to the inter-symbol values. By attenuating selected input modulation symbol(s) a significantly reduced amplitude variation and specifically peak-to-average amplitude variation can be achieved.

### FIELD OF THE INVENTION

The invention relates to reduction of amplitude variation for a transmitter and in particular, but not exclusively, for a transmitter for a cellular communication system.

### BACKGROUND OF THE INVENTION

Cellular communication systems have become an increasingly important part of the communication infrastructure of many countries. Currently, second generation cellular communication systems, such as the Global System for Mobile communication (GSM), is the most widespread technology for supporting mobile telephony and data communication. Furthermore, in recent years, third generation cellular communication systems, such as the Universal Mobile Telecommunication System (UMTS), have been rolled out in many places to provide additional and enhanced communication services.

In order to continuously improve and enhance the communication services that can be provided, significant amounts of research and development are undertaken. For example, although third generation cellular communication systems are still in the process of the initial roll out, work is already undergoing in developing and standardising further enhancements. Specifically, the 3rd Generation Partnership Project (3GPP), which is the standardisation body responsible for defining the third generation cellular communication systems (including UMTS), are already considering new technologies for improved air interface communications. This work is undertaking under the working title of E-UTRA (Evolved-UMTS Terrestrial Radio Access).

A promising air interface technique proposed for E-UTRA is known as Discreet Fourier Transform-Spread Orthogonal Frequency Division Multiplex (DFT-SOFDM). In particular, DFT-SOFDM has been proposed for the uplink transmissions of E-UTRA.

FIG. 1 illustrates an example of a DFT-SOFDM transmitter in accordance with prior art. The transmitter is arranged to receive a number of data bits in a serial-to-parallel converter 101 that converts the data into suitable groups. Each of the groups of data bits are then mapped into a modulation symbol by bit-to-constellation mappers 103. The modulation symbols have an order that corresponds to the number of data bits in each group.

The output of the bit-to-constellation mappers 103 consists in blocks of M modulation symbols. Each block of M modulation symbols is fed to an M-point Discrete Fourier Transform (DFT) 105 which specifically can be a Fast Fourier Transform (FFT). The output of the DFT 105 consists in M frequency domain data values corresponding to the M input modulation symbols.

The M frequency domain data values are fed to an N-point Inverse Discrete Fourier Transform (IDFT) 107 which specifically can be an Inverse Fast Fourier Transform (IFFT). N is larger than M and thus the M frequency domain data values are fed to a subset of M subcarriers out of the N subcarriers of the IDFT 107. The remaining N-M subcarriers are set to zero.

The output of the IDFT 107 corresponds to a time domain transmit signal which can be transmitted without modification. However, in the transmitter of FIG. 1 the time domain transmit signal is fed to a cyclic prefix processor 109 which adds a cyclic prefix as is well known from e.g. OFDM transmitters.

The overall effect of the DFT 105 and the IDFT 107 corresponds to an upsampling and frequency shift of the time domain signal made up of the input modulation symbols.

DFT-SOFDM has a number of advantages including reduced amplitude variations compared to basic OFDM; efficient implementation of transmitter and receiver processing by means of FFT/IFFT algorithms; high spectral efficiency due to lack of roll-off in the frequency response; and ability to position the M frequency subcarriers flexibly within the N available sub-carriers, which allows advanced techniques such as frequency domain scheduling to be employed.

However, although one of the advantages of DFT-SOFDM is that the amplitude variations may be reduced in comparison to a basic OFDM solution, it is still higher than that of many modulation techniques and results in the requirement for transmit power amplifiers to be significantly backed-off thereby resulting in reduced efficiency and transmit power and/or increased distortion.

A suitable measure for the amplitude variation and required power amplifier back-off is the Peak to Average Ratio (PAR) which is typically used to characterise the amplitude variation characteristic. A measure of the amplitude variation which tends to more closely reflect the required amplifier back-up is the Cubic Metric (CM) measure.

Different methods have been proposed for PAR or CM reduction for DFT-SOFDM but these tend to all have a number of associated disadvantages. For example, the modulation symbols can be pulse shaped but this has the disadvantage of increasing the excess bandwidth required thereby resulting in a less spectrally efficient system. As another example, it has been proposed to simply limit (clip) the time domain transmit signal but this results in increased distortion and leads for example to loss of orthogonality between sub-carriers.

Hence, an improved transmitter system would be advantageous and in particular a system allowing for increased flexibility, improved performance, reduced amplitude variation, reduced power amplifier back-off, improved efficiency, reduced distortion, increased transmit power and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a transmitter comprising: means for generating a block of input modulation symbols; means for performing an M-point discrete Fourier transform on the block of input modulation symbols to generate a frequency domain symbol block; means for performing an N-point inverse discrete Fourier transform on the frequency domain block to generate a time domain transmit signal, N being an integer larger than M; first means for determining inter-symbol values corresponding to inter-symbol times of the time domain transmit signal; and means for attenuating at least one of the input modulation symbols in response to the inter-symbol values.

The invention may provide an improved transmitter. In particular, the invention may allow a reduced amplitude variation of the time domain transmit signal thereby allowing a reduced power amplifier back-off and/or increased efficiency and/or reduced distortion. An improved communication in a communication system can be achieved thereby improving the performance of the communication system as a whole.

The invention may provide a practical way of reducing the amplitude variations of the time domain transmit signal which can be implemented with low complexity.

It will be appreciated that the frequency domain symbol block may be modified or processed before being applied to the means for performing an N-point inverse discrete Fourier transform (for example pulse shaping may be applied).

According to an optional feature of the invention, the inter-symbol values are mid-symbol values.

This may allow particular advantageous performance and may specifically allow reduced amplitude variation and/or facilitated implementation. In particular, the Inventors have realised that accurate indications of peak amplitude variations can be determined from the mid-symbol values thereby allowing the process to be predominantly or exclusively based on mid-symbol values.

According to an optional feature of the invention, the first means comprises an interpolation filter having a transfer characteristic corresponding to a transfer characteristic of the M-point discrete Fourier transform and the N-point inverse discrete Fourier transform.

This may allow particular advantageous performance and may specifically allow reduced amplitude variation and/or facilitated implementation. The feature may in particular allow an accurate and low complexity determination of the need to attenuate input modulation symbols.

The interpolation filter may correspond to the transfer function of the cascade of the M-point discrete Fourier transform and the N-point inverse discrete Fourier transform.

According to an optional feature of the invention, the interpolation filter is arranged to perform a circular convolution of a predetermined signal and the block of input modulation symbols.

This may allow a practical, easy to implement and/or low complexity implementation which provides reliable determination of the preference for attenuation of input modulation symbols.

According to an optional feature of the invention, the predetermined signal corresponds to an impulse response of a square frequency response interpolation filter for mid-sample values.

This may allow a practical, easy to implement and/or low complexity implementation which provides reliable determination of the preference for attenuation of input modulation symbols.

According to an optional feature of the invention, the first means comprises: means for performing an M-point Discrete Fourier Transform on the block of input modulation symbols to generate a frequency domain interpolation data block; means for multiplying data of the frequency domain interpolation data block by a set of predetermined values to generate a modified frequency domain interpolation data block; and means for performing an M-point Inverse Discrete Fourier Transform on the modified frequency domain interpolation data block to generate the inter-symbol values.

This may allow a practical, easy to implement and/or low complexity implementation which provides reliable determination of the preference for attenuation of input modulation symbols.

According to an optional feature of the invention, the first means comprises: means for performing an M-point Discrete Fourier Transform on the block of input modulation symbols to generate a first frequency domain interpolation data block comprising M frequency domain values; means for generating a second frequency domain interpolation data block comprising the M frequency domain values and (K−1)*M zero values, where K is an integer larger than one; and means for performing a K*M-point Inverse Discrete Fourier Transform on the second frequency domain interpolation data block to generate the inter-symbol values.

This may allow a practical, easy to implement and/or low complexity implementation which provides reliable determination of the preference for attenuation of input modulation symbols. In particular, it may allow an efficient and direct determination of mid-symbol values.

According to an optional feature of the invention, the first means is arranged to generate the inter-symbol values by selecting M data samples corresponding to mid-symbol data values from K*M time domain data values of the K*M-point Inverse Discrete Fourier Transform.

This may allow a practical, easy to implement and/or low complexity implementation which provides reliable determination of the preference for attenuation of input modulation symbols. In particular, it may allow an efficient and direct determination of mid symbol values.

According to an optional feature of the invention, the means for attenuating is arranged to reduce the at least one input modulation symbol in response to a detection of a first inter-symbol meeting a first amplitude criterion.

This may allow a direct and reliable determination of the preference of attenuating input modulation symbol(s).

According to an optional feature of the invention, the first amplitude criterion comprises a requirement that an amplitude measure of the first inter-symbol exceeds a threshold.

This may allow a direct and reliable determination of the preference for attenuating input modulation symbol(s). The feature may allow a low complexity yet reliable implementation. The amplitude measure may be a direct or indirect indication of the amplitude of the first inter-symbol such as an amplitude value or an absolute value of the first inter-symbol.

According to an optional feature of the invention, the means for attenuating is arranged to attenuate the at least one of the input modulation symbols in response to an amplitude of the first inter-symbol.

This may allow improved performance and may in particular allow a more flexible and efficient attenuation of the input modulation symbol(s) that more closely reflects the instantaneous characteristics of the input modulation symbol(s).

According to an optional feature of the invention, the means for attenuating is arranged to attenuate the at least one of the input modulation symbols by a coefficient proportional to the cube of the amplitude of the first inter-symbol.

This may allow improved performance and may in particular allow a more flexible and efficient attenuation of the input modulation symbol(s) that more closely reflects the instantaneous characteristics of the input modulation symbol(s). The attenuation by a coefficient proportional to the cube of the amplitude of the first inter-symbol has been found to provide particularly advantageous performance.

According to an optional feature of the invention, the means for attenuating is arranged to completely attenuate the at least one of the input modulation symbols.

The input modulation symbol(s) may be completely attenuated by setting the symbol value to substantially zero. This may allow a low complexity implementation with efficient performance and amplitude variation reduction.

According to an optional feature of the invention, the means for attenuating is arranged to attenuate only one quadrature channel of the at least one of the input modulation symbols.

For example, the means for attenuating may attenuate only the I-value or the Q-value of an input modulation symbol.

This may allow a low complexity implementation with efficient performance and amplitude variation reduction.

According to an optional feature of the invention, the transmitter is a Discrete Fourier Transform-Spread Orthogonal Frequency Domain Multiplex (DFT-SOFDM) transmitter.

The invention may in particular allow an improved DFT-SOFDM transmitter.

According to another aspect of the invention, there is provided, a cellular communication system comprising a transmitter, the transmitter comprising: means for generating a block of input modulation symbols; means for performing an M-point discrete Fourier transform on the block of input modulation symbols to generate a frequency domain symbol block; means for performing an N-point inverse discrete Fourier transform on the frequency domain block to generate a time domain transmit signal, N being an integer larger than M; first means for determining inter-symbol values corresponding to inter-symbol times of the time domain transmit signal; and means for attenuating at least one of the input modulation symbols in response to the inter symbol values.

According to an optional feature of the invention, the transmitter is an uplink transmitter.

The invention may allow particularly improved uplink performance in a cellular communication system.

According to another aspect of the invention, there is provided, a method of transmitting comprising: generating a block of input modulation symbols; performing an M-point discrete Fourier transform on the block of input modulation symbols to generate a frequency domain symbol block; performing an N-point inverse discrete Fourier transform on the frequency domain block to generate a time domain transmit signal, N being an integer larger than M; determining inter-symbol values corresponding to inter-symbol times of the time domain transmit signal; and attenuating at least one of the input modulation symbols in response to the inter symbol values.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a DFT-SOFDM transmitter in accordance with prior art;

FIG. 2 illustrates a DFT-SOFDM transmitter in accordance with some embodiments of the invention;

FIG. 3 illustrates a DFT-SOFDM transmitter in accordance with some embodiments of the invention;

FIG. 4 illustrates a transfer characteristic corresponding to a combined operation of a discrete Fourier transform and an inverse discrete Fourier transform.

FIG. 5 illustrates a DFT-SOFDM transmitter in accordance with some embodiments of the invention; and

FIG. 6 illustrates a table showing the improvements provided by the invention.

### DETAILED DESCRIPTION OF THE EMBODIMENTS OF THE INVENTION

The following description focuses on embodiments of the invention applicable to a cellular communication system but it will be appreciated that the invention is not limited to this application but may be applied in many other communication systems.

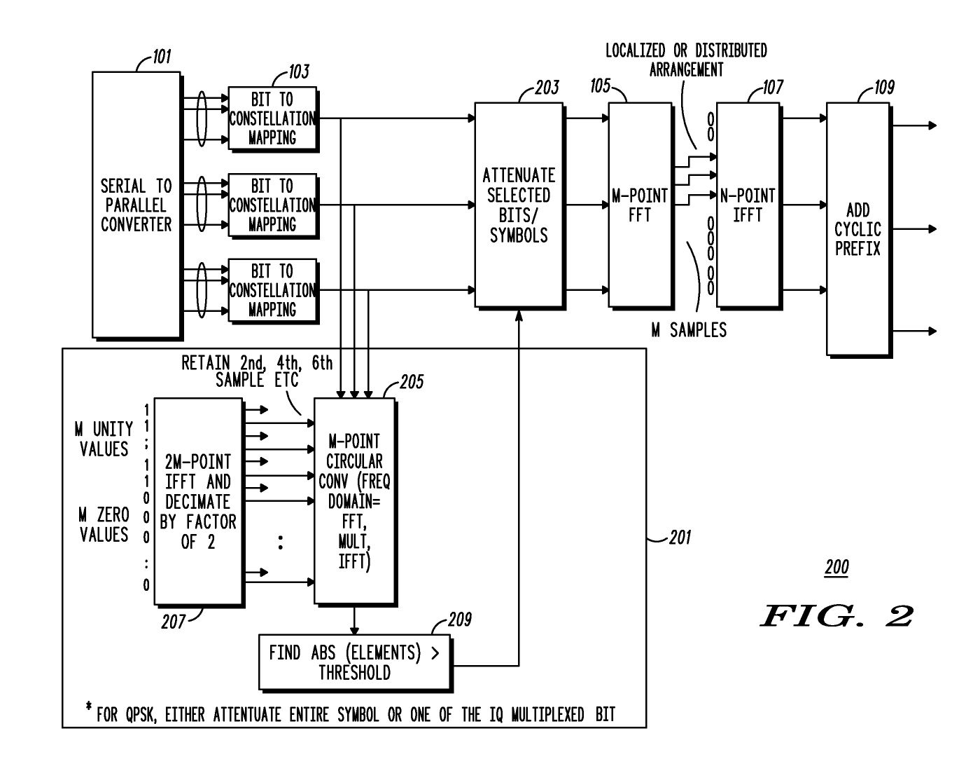

FIG. 2 illustrates a DFT-SOFDM transmitter 200 in accordance with some embodiments of the invention. The transmitter 200 is specifically a transmitter of a remote terminal of a cellular communication system and is transmitting data to a base station of the cellular communication system using a suitable uplink air interface communication channel.

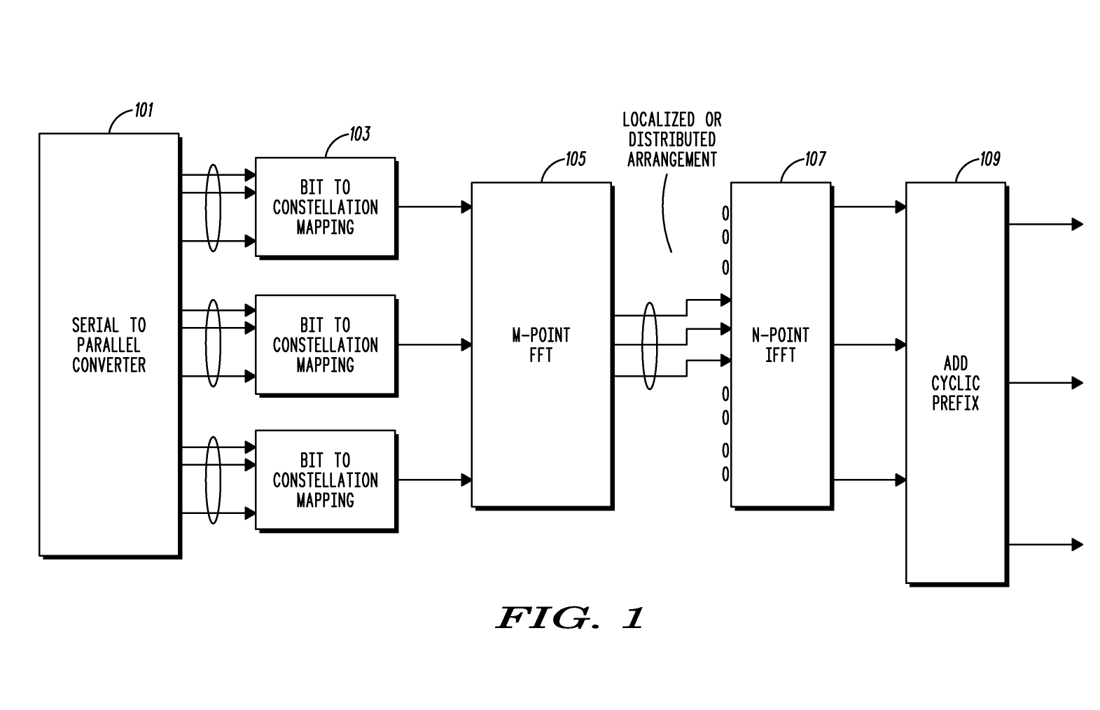

The transmitter 200 is a modified version of the prior art transmitter of FIG. 1 and comprises a serial-to-parallel a converter 101, bit-to-constellation mappers 103, an M-point DFT 105, an N-point IDFT 107 (wherein N is larger than M) and a cyclic prefix processor 109 as will be well known to the person skilled in the art and which have already been described with reference to FIG. 1.

In addition, the transmitter 200 comprises circuitry for reducing the amplitude variations and in particular the PAR and CM of the time domain transmit signal generated by the N-point IDFT 107. Specifically, the transmitter 200 comprises an inter-symbol processor 201 which is coupled to the bit-to-constellation mappers 103 and which is arranged to determine inter-symbol values corresponding to inter-symbol times of the time domain transmit signal. The inter-symbol processor 201 is coupled to an attenuation processor 203 which is inserted between the bit-to-constellation mappers 103 and the M-point DFT 105. The attenuation processor 203 is arranged to attenuate one or more of the input modulation symbols from the bit-to-constellation mappers 103 in response to the inter-symbol values.

Specifically, the bit-to-constellation mappers 103 can determine time domain blocks comprising M modulation symbols. These M modulation symbols are fed to the inter-symbol processor 201 which determines inter-symbol values corresponding to the time domain waveform signal that results from the processing by the DFT 105 and the IDFT 107. These inter-symbol values are then used to determine if any of the M modulation symbols should be attenuated before being fed to the DFT 105. If so, the attenuation processor 203 attenuates the identified modulation symbols before feeding these to the DFT 105.

The Inventors of the current invention have realised that effective attenuation of the amplitude variations, and in particular the reduction of the peak amplitude values, can efficiently be achieved by attenuating one or more selected input modulation symbols to the DFT 105. Furthermore, the Inventors have realised that the determination of when and which symbols to attenuate can be accurately assessed from consideration of inter-symbol values rather than from the modulation symbol values themselves.

Specifically, the Inventors have realised that for transmitters such as that of FIG. 2, the modulation symbol values are replicated (possibly with a phase shift) in the time domain transmit signal but that the peak amplitude values occur in the time intervals between the symbol value instants rather than at the symbol times. Furthermore, the Inventors have realised that the combined behaviour of the DFT 105 and the IDFT 107 is such that very large mid-symbol amplitude values can result for some modulation symbol sequences.

The Inventors have furthermore realised that the combined operation of the DFT 105 and the IDFT 107 is such that the high amplitude peaks are caused by relatively few modulation symbol values and that the high amplitude peaks can be very effectively reduced by attenuating a few (or one) carefully selected input modulation symbol(s) prior to these being fed to the DFT 107.

More specifically, any DFT-SODFM transmission can be represented in the time domain by an up-sampling operation, followed by repetition (distributed case) and frequency shift. The peak-to-average properties are defined by the up-sampling operation, since repetition and frequency shift do not impact the amplitude (due to the data values being complex values). The up-sampling operation interpolates between input samples i.e. some output samples equal the input modulation symbols directly (or are phase shifted versions of the input symbols) and therefore have well controlled amplitudes.

However, between these input modulation symbol points, the amplitude is less well controlled. Indeed, the amplitude may reach peak values mid-way between the input modulation symbols. This amplitude will be maximised when the contribution from the different input modulation symbols add constructively, and the inter-symbol processor 201 is arranged to detect such peaks and to control the attenuation processor 203 to destroy the correlation between these by attenuating one or more of the input modulation symbols contributing significantly to the peak amplitude.

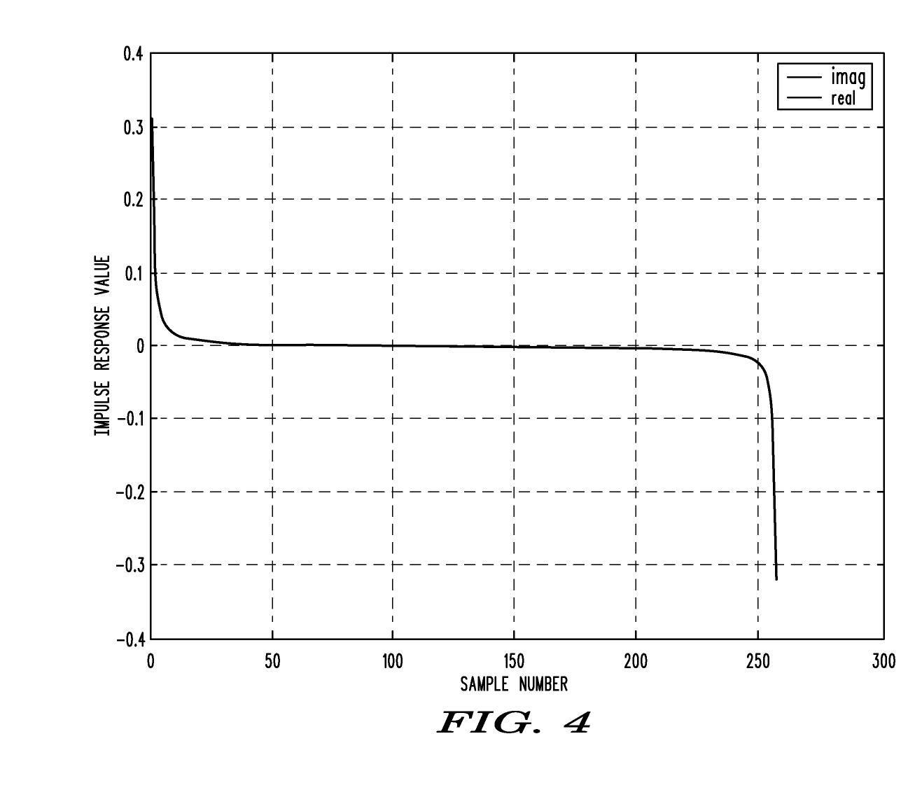

Specifically, FIG. 4 illustrates a transfer characteristic corresponding to the combined operation of the DFT 105 and the IDFT 107 for M=256. The amplitude will attain a peak value when the input modulation symbol values correlate with this impulse response such that the resulting contributions become aligned in phase. However, as can be seen, the impulse response is extremely narrow and is predominantly determined by the contribution from a few input modulation symbols around the current input modulation symbol. Thus, a high correlation peak can be significantly reduced by attenuating the current input modulation symbol or one or more symbols close to the current input modulation symbol.

In the transmitter 200 of FIG. 2, the inter-symbol processor 201 is arranged to predict the occurrence of these high peaks in which case the corresponding input modulation symbol(s) is attenuated to reduce the peak amplitude value, thereby reducing the PAR and CM and thus the required power amplifier back-off.

In particular, the inter-symbol processor 201 of FIG. 2 implements an interpolation filter which interpolates between the input modulation symbols to generate the mid-symbol data values of the time domain transmit signal. Furthermore, the interpolation filter is designed such that it has a transfer characteristic that corresponds to the transfer characteristic of the cascade of the DFT 105 and the IDFT 107.

The interpolation filter can be implemented in different ways. One example is illustrated in FIG. 2 where the inter-symbol processor 201 comprises a circular convolution processor 205 that performs a circular convolution of a predetermined signal and the input modulation symbols. By selecting a suitable predetermined signal, the overall effect of the circular convolution is that it for mid-symbol values corresponds to the processing in the DFT 105 and IDFT 107. Specifically it generates mid-symbol values which directly correspond to the mid-symbol values of the time domain transmission signal. Thus, the predetermined signal can be selected such that the circular convolution processor 205 implements the transfer function of FIG. 4.

The circular convolution processor 205 can specifically calculate the metric given by:

v=x [symbol] r=idft(dft(s).*dft(r))

Where [symbol] represents circular convolution; “.*” represents element-wise multiplication; s is the length M vector of input modulation symbols; and r is a length M reference vector given by:

^{r}ₖ = x _{2k+1 for k=0, 1,..., M-1}
x = idft(d)
^{d}ₖ =1 for k=0, 1,..., M−1
=0 for k=M, M+1,..., 2M−1

This predetermined signal can be generated by performing a 2M-point IFFT on M unity value samples and M zero value samples corresponding to a square frequency response (a brick wall filter response). The resulting predetermined signal is then decimated by a factor of 2 to result in a predetermined signal of M data values corresponding to a time domain representation of a square frequency response filter at the inter-symbol sample points.

Since convolution in the time domain corresponds to multiplication in the time domain, the circular convolution processor 205 can specifically implement the convolution by performing a conversion to the frequency domain, multiplying by a predetermined signal corresponding to a frequency domain representation of the time domain predetermined signal, and converting the resulting result back to the time domain.

Thus, in such an embodiment, the circular convolution processor 205 can implement an M-point DFT which is applied to each block of M input modulation symbols, a multiplication element for multiplying the DFT output by a suitable set of predetermined values and an M-point IDFT which converts the resulting data values back to the time domain thereby generating M inter-symbol values for the M input modulation symbols.

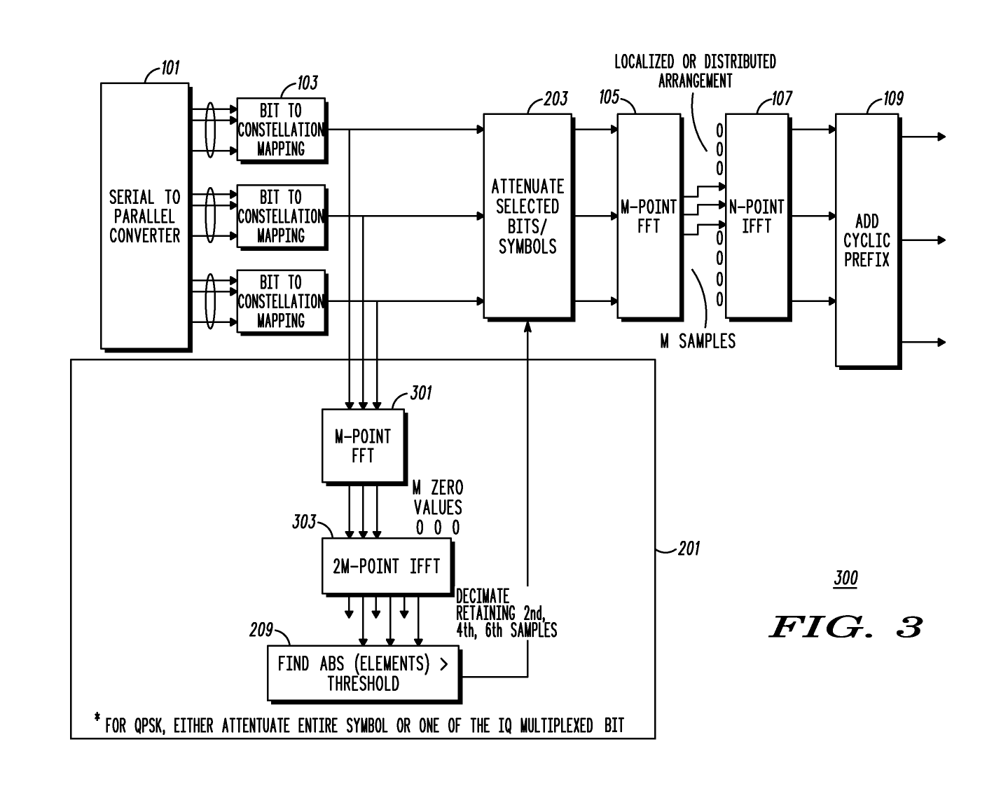

As another example shown in FIG. 3, the inter-symbol processor 201 can generate the M mid-symbol values without applying a predetermined signal. Specifically, the inter-symbol processor 201 can implement an M-point DFT 301 which translates each block of M input modulation symbols to M frequency values. These M input modulation symbols can then be combined into a 2M signal by zero stuffing, i.e. by adding M zero values to the signal. Thus, the combined signal of 2M frequency domain values corresponds to a square frequency response (a brick wall filter).

The circular convolution processor 205 in this example furthermore comprises a 2M-point IFFT 303 which transforms the 2M frequency domain values back to a time domain signal of 2M sample values. Half of these sample values correspond to the original input modulation symbols and the other half correspond to mid-symbol values that will result from the processing of the DFT 105 and the IDFT 107. Thus, by selecting alternating data values, the M mid-symbol values can be generated.

In the example of FIG. 2, the M mid-symbol values are fed to a detection processor 207 which determines if any mid-symbol values have an amplitude that requires attenuation.

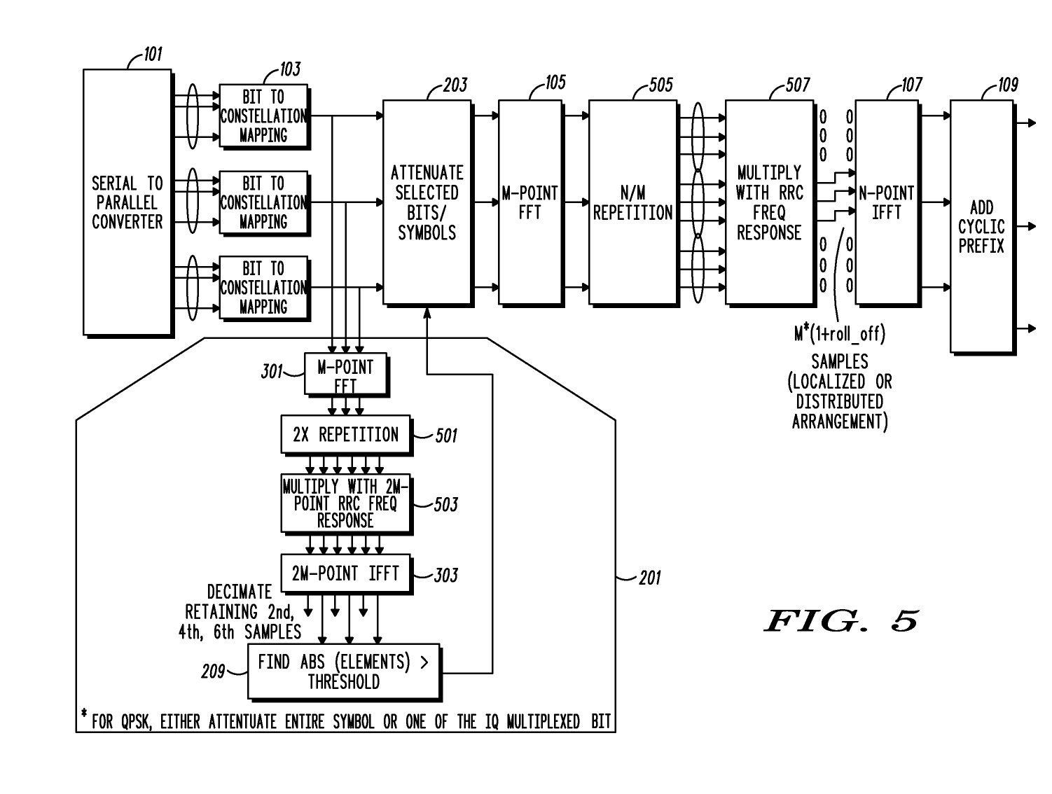

As another example shown in FIG. 5, the inter-symbol processor 201 again generates the M mid-symbol values without applying a predetermined signal. Specifically, the inter-symbol processor 201 implements an M-point DFT 301 which translates each block of M input modulation symbols to M frequency values. These M frequency values are processed 501 to provide a two-times repetition of the block of M frequency values. The resultant repeated 2M symbols are then multiplied 503 with the 2M-point frequency response (e.g. a Root Raised Cosine (RRC) frequency response) to generate a pulse-shaped frequency domain interpolation data block. These 2M frequency domain symbols are then processed by IDFT processing block 303 to obtain 2M time domain symbols.

Half of these sample values correspond to the original input modulation symbols and the other half correspond to mid-symbol values that will result from the processing of the DFT 105, an N/M repetition 505, which are then multiplied 507 with the RRC frequency response to produce M*(1+roll_off) samples (having a localized or distributed arrangement), and then processed by the IDFT 107. Thus, by selecting alternating data values, the M mid-symbol values can be generated.

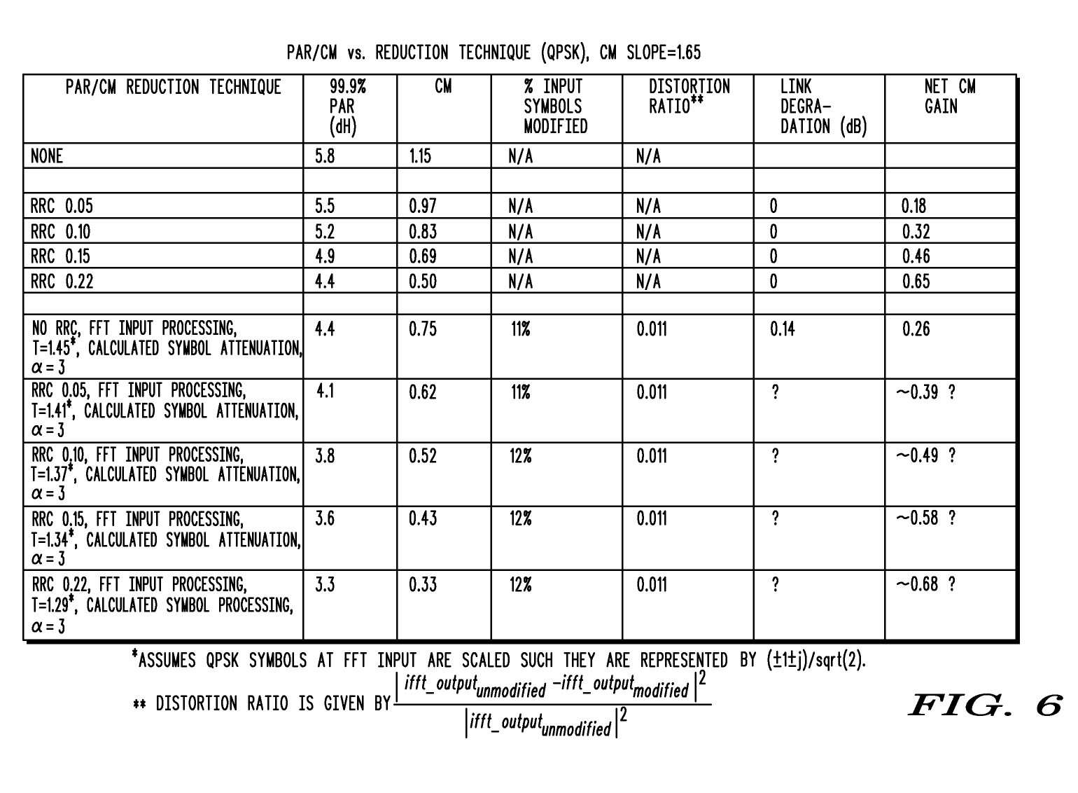

FIG. 6 shows a table of the improved results provided by applicants' invention. The column labelled “PAR/CM reduction technique” indicates the technique, under which the rows labelled “None” and “RRC X.XX” are, without the invention (where X.XX refers to the roll-off of a root raised cosine filter), and the remaining rows include the technique including the invention (described as “FFT input processing”). “T” refers to the threshold used to select samples to attenuate, and α=3 indicates that the attenuation amount is a function of the cube of a metric. The column labelled “99.9% PAR (dB)” gives the 99.9 percentile peak to average power ratio e.g. a value of 5.8 indicates that 99.9% of the time the signal power is less than 5.8 dB above the average signal power. The column “CM” refers to another measure of signal variability known in the art as “Cubic Metric” which is a measure of amplifier backoff required. The column “% of symbols modified” refers to the percentage of input symbols that are attenuated as a result of applying the present invention. The “Distortion Ratio” is a measure of distortion on the output of the IFFT introduced by the present invention. The column labelled “link degradation” provides the increase in transmission power in dB that is required to overcome the impacts of the distortion (i.e. to achieve the same link performance in terms of decoded error rate). The column labelled “net CM gain” gives the NET gain in PA backoff and is the gain in CM over the row labelled “None”, less the link degradation.

For a given RRC filter roll-off, it can be seen that there is a gain due to the present invention. For example with no roll-off, there is a net gain of 0.26 dB due to the present invention. With roll-off 0.05, without the invention the net gain is 0.18 whereas with the invention the net gain is 0.39.

It will be appreciated that the functionality separation indicated by FIGS. 2, 3 and 5 is merely exemplary and included only for the purpose of description of the approach, and in particular that although the detection processor 207 is shown as part of the inter-symbol processor 201 in FIG. 2, it can equally be considered to be part of the attenuation processor 203 or can be considered a separate functional element.

The detection processor 207 is arranged to evaluate an amplitude criterion for all the M mid-symbol values. The amplitude criterion can be a simple criterion, such as for example a simple detection of all inter-symbol values that have an amplitude exceeding a predetermined threshold or a threshold scaled in accordance with the amplitude input modulation symbols. For each such inter-symbol value, one or two of the surrounding input modulation symbols can e.g. be selected for attenuation and the identification of these can be fed to the attenuation processor 203.

The attenuation of the selected input modulation symbol(s) can be a complete attenuation corresponding to the input symbol being set to zero. This may result in a simple and efficient reduction of the amplitude but may in some embodiments result in an error probability which is unacceptable. In some embodiments, the attenuation may be limited to only one of the quadrature channels, i.e. to either the I-data or Q-data value.

Specifically, the attenuation amount can be fixed. For example the entire symbol or the entire bit can be attenuated to zero if the calculated amplitude of the inter-symbol value is above a threshold, i.e.:

input_symbolᵢ = input_symbolᵢ * weight
where weight = 0 if calculated amplitude_{i+1/2} > threshold; =1 otherwise

Alternatively, an attenuation amount can be calculated. Specifically, the attenuation can be determined in response to the amplitude of the inter-symbol value. For example the attenuation amount can be applied as follows:

input_symbolᵢ = input_symbolᵢ * weightᵢ
where weightᵢ = (threshold/amplitude_{i+1/2} )³ if calculated amplitude_{i+1/2} > threshold; =1 otherwise.

By attenuating the input modulation symbol by a value proportional to the cube of the amplitude, a particularly advantageous amplitude reduction suitable for efficient power amplifier back-off has been found to be achieved.

One of the advantages of the described approach is that, in contrast to previously proposed techniques based on pulse shaping, it maintains the spectral efficiency of DFT-SOFDM. Furthermore, unlike clipping at the IFFT output, this approach also maintains perfect orthogonality between the sub-carriers. Furthermore, simulations have shown that the degradation in link performance is small as long as the number of attenuated input modulation symbol is relatively small.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A transmitter comprising:
means for generating a block of input modulation symbols;
means for performing an M-point discrete Fourier transform on the block of input modulation symbols to generate a frequency domain symbol block;
means for performing an N-point inverse discrete Fourier transform on the frequency domain block to generate a time domain transmit signal, N being an integer larger than M;
first means for determining inter-symbol values corresponding to inter-symbol times of the time domain transmit signal; and
means for attenuating at least one of the input modulation symbols in response to the inter-symbol values.

2. The transmitter of claim 1 wherein the inter-symbol values are mid-symbol values.

3. The transmitter of claim 1 wherein the first means comprises an interpolation filter having a transfer characteristic corresponding to a transfer characteristic of the M-point discrete Fourier transform and the N-point inverse discrete Fourier transform.

4. The transmitter of claim 1 wherein the outputs of the M-point discrete Fourier transform are repeated N/M times and multiplied by a N point frequency response prior to the N point inverse discrete Fourier transform; and wherein the first means comprises an interpolation filter having a transfer characteristic corresponding to a transfer characteristic of the M-point discrete Fourier transform, the N/M repetition, the multiplication by frequency response and the N-point inverse discrete Fourier transform.

5. The transmitter of claim 4 wherein the interpolation filter is arranged to perform a circular convolution of a predetermined signal and the block of input modulation symbols.

6. The transmitter of claim 5 wherein the predetermined signal corresponds to an impulse response of a square frequency response interpolation filter for mid-sample values.

7. The transmitter of claim 5 wherein the predetermined signal corresponds to an impulse response of a root raised cosine frequency response interpolation filter for mid-sample values.

8. The transmitter of claim 1 wherein the first means comprises:
means for performing an M-point Discrete Fourier Transform on the block of input modulation symbols to generate a frequency domain interpolation data block;
means for providing a K-times repetition of the interpolation data block, where K is an integer larger than one;
means for multiplying data of the repeated frequency domain interpolation data block by a RRC frequency response to generate a pulse-shaped frequency domain interpolation data block; and
means for performing a K*M-point Inverse Discrete Fourier Transform on the modified frequency domain interpolation data block to generate the inter-symbol values.

9. The transmitter of claim 8 wherein the first means comprises:
means for performing an M-point Discrete Fourier Transform on the block of input modulation symbols to generate a first frequency domain interpolation data block comprising M frequency domain values;
means for generating a second frequency domain interpolation data block comprising the M frequency domain values and (K−1)*M zero values, where K is an integer larger than one; and
means for performing a K*M-point Inverse Discrete Fourier Transform on the second frequency domain interpolation data block to generate the inter-symbol values.

10. The transmitter of claim 9 wherein the first means is arranged to generate the inter-symbol values by selecting M data samples corresponding to mid-symbol data values from K*M time domain data values of the K*M-point Inverse Discrete Fourier Transform.

11. The transmitter of claim 1 wherein the means for attenuating is arranged to reduce the at least one input modulation symbol in response to a detection of a first inter-symbol meeting a first amplitude criterion.

12. The transmitter of claim 11 wherein the first amplitude criterion comprises a requirement that an amplitude measure of the first inter-symbol exceeds a threshold.

13. The transmitter of claim 11 wherein the means for attenuating is arranged to attenuate the at least one of the input modulation symbols in response to an amplitude of the first inter-symbol.

14. The transmitter of claim 11 wherein the means for attenuating is arranged to attenuate the at least one of the input modulation symbols by a coefficient proportional to the cube of the amplitude of the first inter-symbol.

15. The transmitter of claim 1 wherein the means for attenuating is arranged to completely attenuate the at least one of the input modulation symbols.

16. The transmitter of claim 1 wherein the means for attenuating is arranged to attenuate only one quadrature channel of the at least one of the input modulation symbols.

17. The transmitter of claim 1 wherein the transmitter is a Discrete Fourier Transform-Spread Orthogonal Frequency Domain Multiplex (DFT-SOFDM) transmitter.

18. A cellular communication system comprising a transmitter, the transmitter comprising:
means for generating a block of input modulation symbols;
means for performing an M-point discrete Fourier transform on the block of input modulation symbols to generate a frequency domain symbol block;
means for performing an N-point inverse discrete Fourier transform on the frequency domain block to generate a time domain transmit signal, N being an integer larger than M;
first means for determining inter-symbol values corresponding to inter-symbol times of the time domain transmit signal; and
means for attenuating at least one of the input modulation symbols in response to the inter symbol values.

19. The cellular communication system of claim 18 wherein the transmitter is an uplink transmitter.

20. The cellular communication system of claim 18 wherein the outputs of the M-point discrete Fourier transform are repeated N/M times and multiplied by a N point frequency response prior to the N point inverse discrete Fourier transform, and wherein the first means comprises an interpolation filter having a transfer characteristic corresponding to a transfer characteristic of the M-point discrete Fourier transform, the N/M repetition, the multiplication by frequency response and the N-point inverse discrete Fourier transform.

21. A method of transmitting comprising:
generating a block of input modulation symbols;
performing an M-point discrete Fourier transform on the block of input modulation symbols to generate a frequency domain symbol block;
performing an N-point inverse discrete Fourier transform on the frequency domain block to generate a time domain transmit signal, N being an integer larger than M;
determining inter-symbol values corresponding to inter-symbol times of the time domain transmit signal; and
attenuating at least one of the input modulation symbols in response to the inter symbol values.

22. The method of claim 21, further comprising the step of providing an N/M-times repetition and multiplication with a N-point RRC frequency response to generate a modified frequency domain symbol block.
